(19) United States
(12) Patent Application Publication
(10) Pub. No.: US 2023/0410496 A1
(43) Pub. Date: Dec. 21, 2023

(54) OMNI-SCALE CONVOLUTION FOR CONVOLUTIONAL NEURAL NETWORKS

(71) Applicant: Intel Corporation, Santa Clara, CA (US)

(72) Inventors: Anbang YAO, Beijing (CN); Bo LIU, Beijing (CN); Ming LU, Beijing (CN); Feng CHEN, Shanghai (CN); Yurong CHEN, Beijing (CN)

(73) Assignee: Intel Corporation, Santa Clara, CA (US)

(21) Appl. No.: 18/252,164

(22) PCT Filed: Dec. 23, 2020
(86) PCT No.: PCT/CN2020/138664

§ 371 Date: May 8, 2023

(51) Int. Cl. G06V 10/82

(52) U.S. Cl. CPC G06V 10/82

(57) ABSTRACT

Omni-scale convolution for convolutional neural networks is disclosed. An example of an apparatus includes one or more processors to process data, including processing for a convolutional neural network (CNN); and a memory to store data, including CNN data, wherein processing of input data by the CNN includes implementing omni-scale convolution in one or more convolutional layers of the CNN, implementation of the omni-scale convolution into a convolutional layer of the one or more convolutional layers including at least applying multiple dilation rates in a plurality of kernels of a kernel lattice of the convolutional layer, and applying a cyclic pattern for the multiple dilation rates in the plurality of kernels of the convolutional layer.

### CLAIM OF PRIORITY

This application claims, under 35 U.S.C. § 371, the benefit of and priority to International Application No. PCT/CN2020/138664, filed Dec. 23, 2020, titled OMNI-SCALE CONVOLUTION FOR CONVOLUTIONAL NEURAL NETWORKS, the entire content of which is incorporated herein by reference.

### FIELD

This disclosure relates generally to machine learning and more particularly to convolutional neural networks.

### BACKGROUND OF THE DISCLOSURE

Neural networks provide a network of neurons that may be applied to an increasing number of technical problems. In particular, deep convolutional neural networks (CNNs) have shown tremendous success in a variety of emerging artificial intelligence (AI) related computer vision applications, including image processing in varying setting, such as image and video recognition, image classification, and medical image analysis, among others.

As AI applications increase in difficulty, the variation in the scale of different instances of objects of interest that are faced by CNNs utilized to provide needed processing also increases, with systems requiring very large numbers of calculations in multiple convolutional layers.

However, CNNs are generally very sensitive to changes in the scale of objects. This limitation is a result of the nature of receptive fields of CNNs, a receptive field being the region of the input space that provides inputs to units within a layer. As CNNs usually have fixed-sized receptive fields, they lack a strong ability to gather diverse information from objects of various sizes and understand meaningful contextual backgrounds. This scale sensitivity can impose significant performance limitations in complex visual recognition tasks.

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate typical embodiments and are therefore not to be considered limiting of its scope. The figures are not to scale. In general, the same reference numbers will be used throughout the drawing(s) and accompanying written description to refer to the same or like parts.

FIG. 1 is an illustration of implementation of omni-scale convolution in a convolutional neural network, according to some embodiments;

FIGS. 2A and 2B illustrate an example of a convolutional neural network that may include implementation of omni-scale convolution, according to some embodiments;

FIG. 3 illustrates a feature pyramid in a CNN operation to provide multi-scale feature extraction operation;

FIG. 4 is an illustration of omni-scale convolution in a convolutional neural network, according to some embodiments;

FIG. 5 is an illustration of dilation space of the kernel lattice in standard, dilated, or group convolution, according to some embodiments;

FIG. 6 is an illustration of dilation space of the kernel lattice in omni-scale convolution, according to some embodiments;

FIG. 7 is a flowchart to illustrate a process for of omni-scale convolution in a convolutional neural network, according to some embodiments; and

FIG. 8 is a schematic diagram of an illustrative electronic computing device to enable omni-scale convolution in a convolutional neural network, according to some embodiments.

### DETAILED DESCRIPTION

Implementations of the disclosure describe omni-scale convolution for convolutional neural networks.

Convolutional neural networks (CNNs) have been applied in many technologies, and are in particular utilized in computer vision applications, wherein computer visions in general refers to artificial systems that obtain information from images, such as image and video recognition, image classification, and medical image analysis, and others. A CNN includes a feature extraction layer or portion, to perform a series of convolutions in which features are detected, and a classification layer or portion in which fully connected layers operate as a classifier to classify on object within an image.

The layers of a CNN may be referred to as the CNN “backbone”, wherein a CNN backbone includes, but is not limited to, prevailing CNN architectures (such as ResNet and DenseNet, which are typically pre-trained on a ImageNet classification dataset) and then are to be fine-tuned (i.e., the originally trained classifiers are replaced with new classifiers) when the CNN is used to handle other computer vision tasks such as object detection, image segmentation, and others.

However, conventional CNN backbones are very scale-sensitive with regard to object size as they generally have fixed-sized receptive fields, and thus lack a strong ability to gather diverse information from objects of various sizes and understand meaningful contextual backgrounds.

Conventional concepts for multi-scale feature fusion emphasize the CNN architecture engineering of either the entire network or their composed building blocks, lacking the generalization ability to apply to a wide range of CNNs. More importantly, the more granular kernel lattice space is completely overlooked. This design deficiency restricts the performance of convolutional neural networks, and in particular places on limits performance in complex visual recognition tasks such as large-scale image classification, object detection, and semantic segmentation.

In some embodiments, an apparatus, system, or process provides omni-scale convolution for convolutional neural networks. In such technology, a convolutional neural network, with regard to a single convolutional filter, is to provide constituent kernels of the filter that utilize a group of dilation rates to extract features corresponding to different receptive fields, wherein the dilation factor or rate indicates how large the gaps between elements are in a feature map on which a convolution filter is applied. Further, with regard to convolutional filters in a single convolutional layer, the group of dilation rates corresponding to each convolutional filter alternates along the axes of input and output channels in a cyclic fashion, extracting diverse scale information from the incoming features and mapping them into outgoing features in a wide range of scales.

In some embodiments, implementation of the omni-scale convolution technology thus includes a combination of a cyclic operation in which dilation rates for a plurality of kernels vary in a periodic manner along an axis of input channels, and a shift operation in which dilation rates for the plurality of kernels are shifted along an axis of output channels.

The omni-scale convolution operation provides a drop-in technology to significantly promote the robustness of CNNs to scale variance, allowing for redesigning of basic convolution operations rather than network architecture engineering for multi-scale feature fusion. The drop-in technology is particularly applicable for boosting the performance of existing CNN backbones without introducing extra computational cost. Furthermore, performance improvements to CNN backbones by implementation of an embodiment can be well transferred to a variety of downstream visual recognition tasks such as object detection, image segmentation, face recognition and so forth.

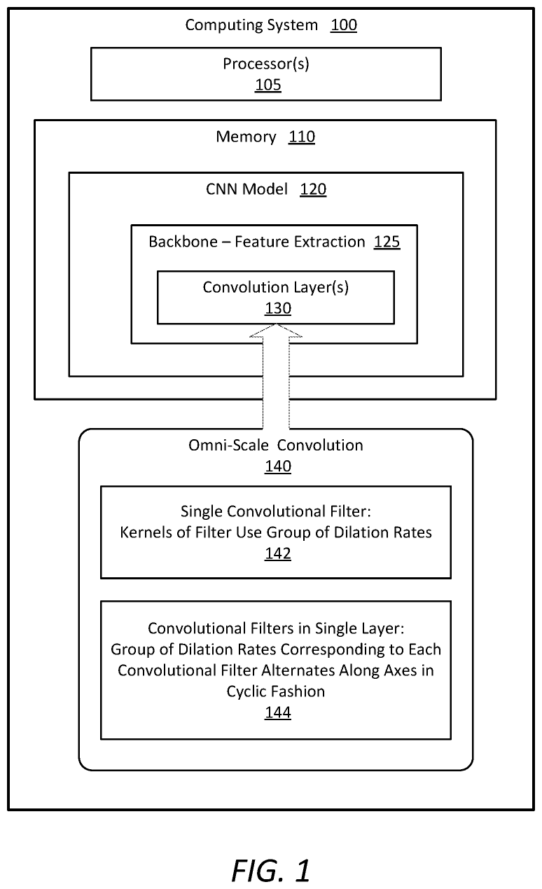

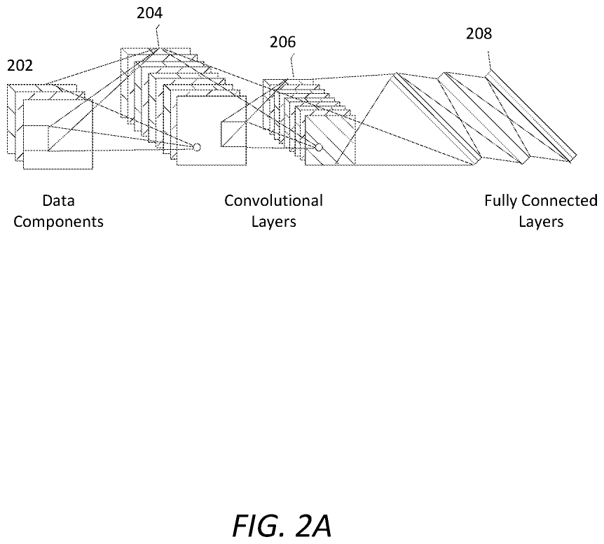

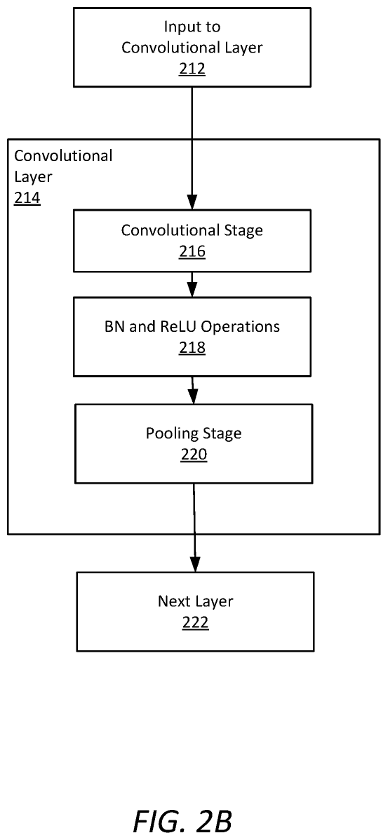

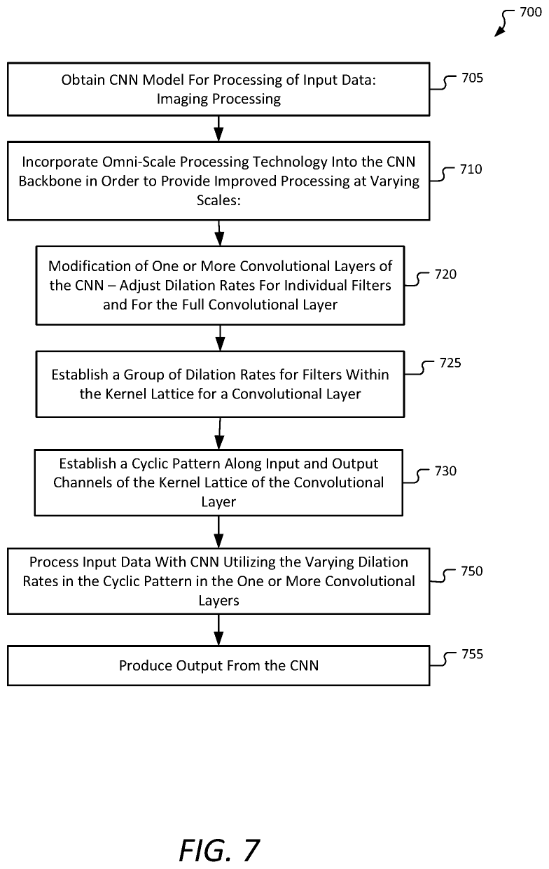

FIG. 1 is an illustration of implementation of omni-scale convolution in a convolutional neural network, according to some embodiments. In this illustration, a computing apparatus or system, components of which are illustrated in more detail in FIG. 7, to provide omni-scale convolution in CNN processing includes processing resources such as resources of one or more processors 105, which may include any of, for example, central processing units (CPUs), graphical processing units (GPUs), embedded processors, or other processors, to provides processing for operations including machine learning with neural network processing. The computing apparatus or system 100 further includes a computer memory 110 to hold data for processing, including a CNN model 120. The CNN includes a backbone 125, or feature extraction portion, including one or more convolutional layers. The structure and operation of a CNN is further illustrated in FIGS. 2A and 2B.

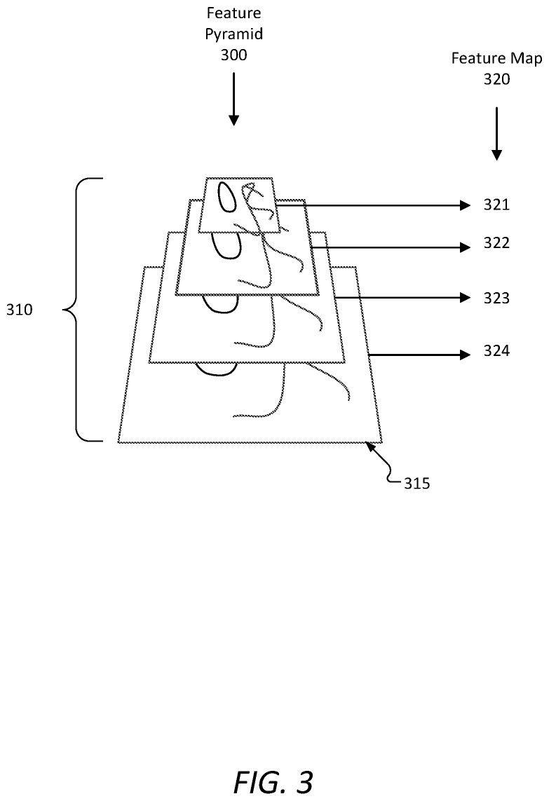

In some embodiments, the computing system provides omni-scale convolution 140, wherein the omni-scale convolution (which may also be referred to herein as OSConv) technology is a tool that utilizes two design principles in order to make each individual convolutional layer in a neural network resemble a feature pyramid (i.e., a pyramid of a same image at different scales utilized in order to detect objects of different sizes, such as illustrated in FIG. 3):
(1) With regard to a single convolutional filter 142, the constituent kernels of the filter are to use a group of dilation rates to extract features corresponding to different receptive fields.
(2) With regard to all convolutional filters in one single layer 144, the group of dilation rates corresponding to each convolutional filter alternates along the axes of input and output channels in a cyclic fashion, extracting diverse scale information from the incoming features and mapping them into outgoing features in a wide range of scales.

Through these atomic operations on individual convolutional kernels, an apparatus, system, or process is capable of effectively reducing or eliminating the scale-sensitive deficiency of modern CNN backbones, and push the multi-scale feature fusion process to a much more granular level. The omni-scale convolution 140 utilizes together a cyclic strategy and a shift strategy to mix up multi-scale information in two orthogonal dimensions of kernel lattice regarding every individual convolutional layers.

In some embodiments, the OSConv technology tool provides a generic plug and play design that may be utilized as a drop-in replacement of the convolution in many conventional CNN backbones, allowing for greatly improved representation learning both for basic image classification task and for transferring pre-trained CNN backbones to downstream tasks such as object detection, image segmentation, face recognition and so forth without introducing additional parameters and computational complexities.

Neural networks, including feedforward networks, CNNs (Convolutional Neural Networks, and RNNs (Recurrent Neural Networks) networks, may be used to perform deep learning. Deep learning refers to machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

FIGS. 2A and 2B illustrate an example of a convolutional neural network that may include implementation of omni-scale convolution, according to some embodiments. Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different tasks.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

FIG. 2A illustrates various layers within a CNN. As shown in FIG. 2A, an exemplary CNN used to, for example, model image processing can receive input 202 describing the red, green, and blue (RGB) components of an input image (or any other relevant data for processing). The input 202 can be processed by multiple convolutional layers (e.g., convolutional layer 204 and convolutional layer 206), which make up the CNN backbone. The output from the multiple convolutional layers may optionally be processed by a set of fully connected layers 208. Neurons in a fully connected layer have full connections to all activations in the previous layer, as previously described for a feedforward network. The output from the fully connected layers 208 can be used to generate an output result from the network. The activations within the fully connected layers 208 can be computed using matrix multiplication instead of convolution. Not all CNN implementations make use of fully connected layers 208. For example, in some implementations the convolutional layer 206 can generate output for the CNN.

The convolutional layers are sparsely connected, which differs from traditional neural network configuration found in the fully connected layers 208. Traditional neural network layers are fully connected, such that every output unit interacts with every input unit. However, the convolutional layers are sparsely connected because the output of the convolution of a field is input (instead of the respective state value of each of the nodes in the field) to the nodes of the subsequent layer, as illustrated. The kernels associated with the convolutional layers perform convolution operations, the output of which is sent to the next layer. The dimensionality reduction performed within the convolutional layers is one aspect that enables the CNN to scale to process large images.

FIG. 2B illustrates exemplary computation stages within a convolutional layer of a CNN. Input to a convolutional layer 212 of a CNN can be processed in certain stages of a convolutional layer 214. The stages (which may be expressed in different forms) can include a convolution stage 216, a Batch Normalization and (BN) and Rectified Linear Unit (ReLU) stage 218, and a pooling stage 220. The convolution layer 214 can then output feature map data to a successive convolutional layer 222. The final convolutional layer of the network can generate output feature map data or provide input to a fully connected layer, for example, to generate a classification value for the input to the CNN.

In the convolution stage 216 several convolutions may be performed in parallel to produce a set of linear activations. The convolution stage 216 can include an affine transformation, which is any transformation that can be specified as a linear transformation plus a translation. Affine transformations include rotations, translations, scaling, and combinations of these transformations. The convolution stage computes the output of functions (e.g., neurons) that are connected to specific regions in the input, which can be determined as the local region associated with the neuron. The neurons compute a dot product between the weights of the neurons and the region in the local input to which the neurons are connected. The output from the convolution stage 216 defines a set of linear activations that are processed by successive stages of the convolutional layer 214.

Convolution operation may be followed by operations of a Batch Normalization and (BN) and Rectified Linear Unit (ReLU) stage 216, wherein BN performs channel-wise feature normalization and ReLU performs non-linear activations collection. The non-linear activation function increases the nonlinear properties of the overall network without affecting the receptive fields of the convolution layer.

A pooling stage 220, which may occur after several convolutional stages, uses a pooling function that replaces the output of the convolutional layer 206 with a summary statistic of the nearby outputs. Pooling may be used to reduce spatial feature size allowing stacking of many convolutional layers (deep CNNs) while not introducing a too heavy computational burden. The pooling function can be used to introduce translation invariance into the convolutional neural network, such that small translations to the input do not change the pooled outputs. Invariance to local translation can be useful in scenarios where the presence of a feature in the input data is more important than the precise location of the feature. Various types of pooling functions can be used during the pooling stage 220, including max pooling, average pooling, and 12-norm pooling. Additionally, some CNN implementations do not include a pooling stage. Instead, such implementations substitute and additional convolution stage having an increased stride relative to previous convolution stages.

The output from the convolutional layer 214 can then be processed by the next layer 222. The next layer 222 can be an additional convolutional layer or one of the fully connected layers 208. For example, the first convolutional layer 204 of FIG. 2A can output to the second convolutional layer 206, while the second convolutional layer can output to a first layer of the fully connected layers 208.

In some embodiments, an apparatus, system, or process for processing of a CNN, such as illustrated FIGS. 2A and 2B, includes the use omni-scale convolution technology.

FIG. 3 illustrates a feature pyramid in a CNN operation to provide multi-scale feature extraction operation. As shown in FIG. 3, a CNN may utilize a feature pyramid 300 in operation in order to assist in addressing scaling limitations of the CNN in detecting objects of varying sizes for computer visions applications. The feature pyramid 300 includes multiple copies 310 of a same image 315 at different scales in order to detect objects of different sizes.

In this process, the multiple copies (which may include any number of 2 or more) of the image may each be subjected to convolution operation in order to provide feature maps at each scale, illustrated as a first feature map 321 for the image at a first scale, a second feature map 322 for the image at a second scale, a third feature map 323 for the image at a third scale, and a fourth feature map 324 for the image at a fourth scale. As used herein, a feature map (or activation map) refers to a mapping of features found within an image by a filter.

In some embodiments, an apparatus, system, or process is to operate in a manner to order to make each individual convolutional layer in a convolutional neural network resemble a feature pyramid through a combination of, for a single convolutional filter, the constituent kernels of the filter to use a group of dilation rates to extract features corresponding to different receptive fields, and, for all convolutional filters in one single layer of the neural network, the group of dilation rates corresponding to each convolutional filter alternating along axes of input and output channels in a cyclic fashion.

To describe such operation, for a single convolutional layer of a CNN the tensor [symbol] ∈ [symbol] ^{C}^{ᵢₙ}^{×H×W} can denote the CNN's input feature map with the size of Cᵢₙ×H×W, where Cᵢₙ is the number of input channels, and H and W are the height and width, respectively. In some embodiments, a set of Cₒᵤₜ filters with the kernel size K×K are then convolved with the input tensor individually to obtain the desired output feature map with Cₒᵤₜ channels, where each filter has Cᵢₙ kernels to match those channels in the input feature map. If the above filters are denoted as G E [symbol] ^{C}^{ₒᵤₜ}^{×C}^{ᵢₙ}^{×K×K}, then the standard convolution operation can be defined as provided in Eq. [1]:

$${c , x , y}_{} = {\sum }_{k = 1}^{{C}_{in}} {\sum }_{i = - \frac{K - 1}{2}}^{\frac{K - 1}{2}} {\sum }_{i = - \frac{K - 1}{2}}^{\frac{K - 1}{2}} {G}_{c , k , i , j} {k , x + i , y + j}_{} \qquad [ 1 ]$$

where [symbol] _{c,x,y} is one element in the output feature map [symbol] ∈ [symbol] ^{C}^{ₒᵤₜ}^{×H×W}, c=1, 2, . . . , Cₒᵤₜ is the index of an output channel, and x=1, 2, . . . , H and y=1, 2, . . . , W are indices of spatial positions in the feature map.

Further, compared with standard convolution, dilated convolution enlarges sampling intervals in the spatial domain to cover objects of larger sizes. A dilated convolution with the dilation rate d can be defined as provided in Eq. [2]:

$${c , x , y}_{} = {\sum }_{k = 1}^{{C}_{in}} {\sum }_{i = - \frac{K - 1}{2}}^{\frac{K - 1}{2}} {\sum }_{i = - \frac{K - 1}{2}}^{\frac{K - 1}{2}} {G}_{c , k , i , j} {k , x + id , y + jd}_{} \qquad [ 2 ]$$

According to the definition in Eq. [2], dilated convolution adds a fixed spatial sampling offset to standard convolution, enlarging the receptive field of convolution operations without introducing learnable parameters.

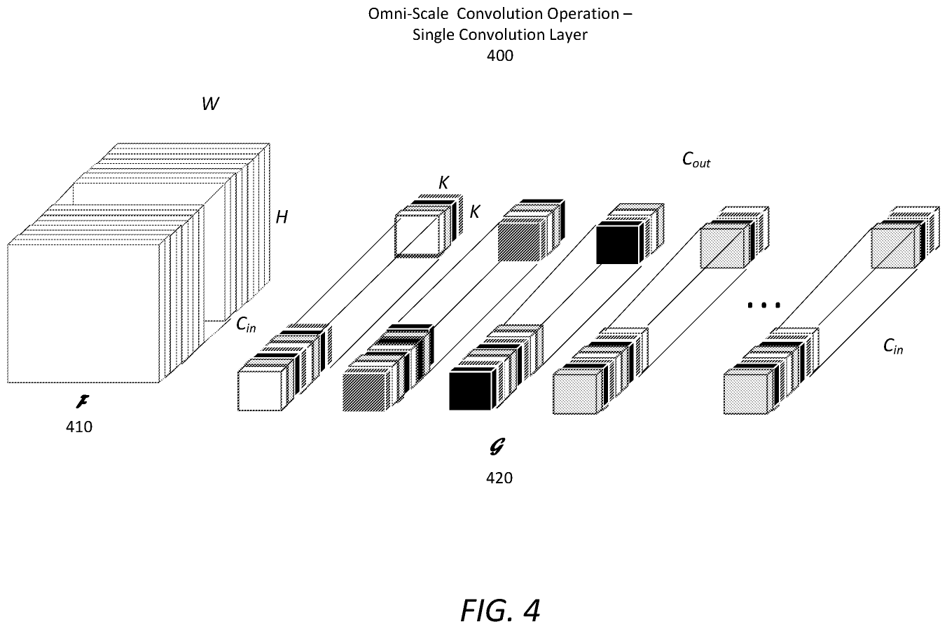

FIG. 4 is an illustration of omni-scale convolution in a convolutional neural network, according to some embodiments. FIG. 4 illustrates an omni-scale convolution operation regarding an individual convolutional layer 400. In some embodiments, the omni-scale technology serves to reformulate the dilation rate patterns in the subspace of kernel lattice by utilizing both a cyclic strategy and a shift strategy.

In this illustration, [symbol] 410 represents the input feature map with the dimensions W, H, and Cᵢₙ ( [symbol] ∈ [symbol] ^{C}^{ᵢₙ}^{×H×W}), and G 420 represents Cₒᵤₜ groups of convolutional filters, with each filter having dimensions K×K (G ∈ [symbol] ^{C}^{ₒᵤₜ}^{×C}^{ᵢₙ}^{×K×K}) In FIG. 4 the different shaded convolutional kernels have different dilation rates, and convolutional kernels with the same dilation rates in the set of filters G E [symbol] ^{C}^{ₒᵤₜ}^{×C}^{ᵢₙ}^{×K×K} are rendered with the same shading.

In some embodiments, the omni-scale convolution (OSConv) technology implements two design principles, thereby making each individual convolutional layer resemble a feature pyramid: First, with regard to a single convolutional filter, the constituent kernels of the convolution filter use a group of dilation rates to extract features corresponding to different receptive fields. Second, with regard to all convolutional filters within a single convolutional layer, the group of dilation rates corresponding to each convolutional filter alternates along the axes of input and output channels in a cyclic fashion, as illustrated in FIG. 4, thereby extracting diverse scale information from the incoming features and mapping them into outgoing features in a wide range of scales. Through these atomic operations on individual convolutional kernels, wan embodiment can effectively dissolve the scale-sensitive deficiency of modern CNN backbones, and push the multi-scale feature fusion process to a more granular level.

In some embodiments, omni-scale convolution may be mathematically described as the following in Eq. [3]:

$${c , x , y}_{} = {\sum }_{k = 1}^{{C}_{in}} {\sum }_{i = - \frac{K - 1}{2}}^{\frac{K - 1}{2}} {\sum }_{i = - \frac{K - 1}{2}}^{\frac{K - 1}{2}} {G}_{c , k , i , j} {k , x + {iD}_{( c , k )} , y + {jD}_{( c , k )}}_{} \qquad [ 3 ]$$

Where D ∈ [symbol] ^{C}^{ₒᵤₜ}^{×C}^{ᵢₙ} is a matrix composed of channel-wise and filter-wise dilation rates in two orthogonal dimensions, the dimensions being input channel space and output channel space. An element D_{(c,k)} is associated with a specific channel in one filter to support G_{c,k}, as a unique convolutional kernel, and thus the whole matrix D can be interpreted as a mathematical representation of the kernel lattice (further described below in relation to FIG. 4) in its subspace of dilation rate. According to the definition in Eq. [3], it can be seen that the omni-convolution integrates multi-scale features into a single operation while also incorporates characteristics of the dilated convolution, which thus be implemented without introducing additional computational cost.

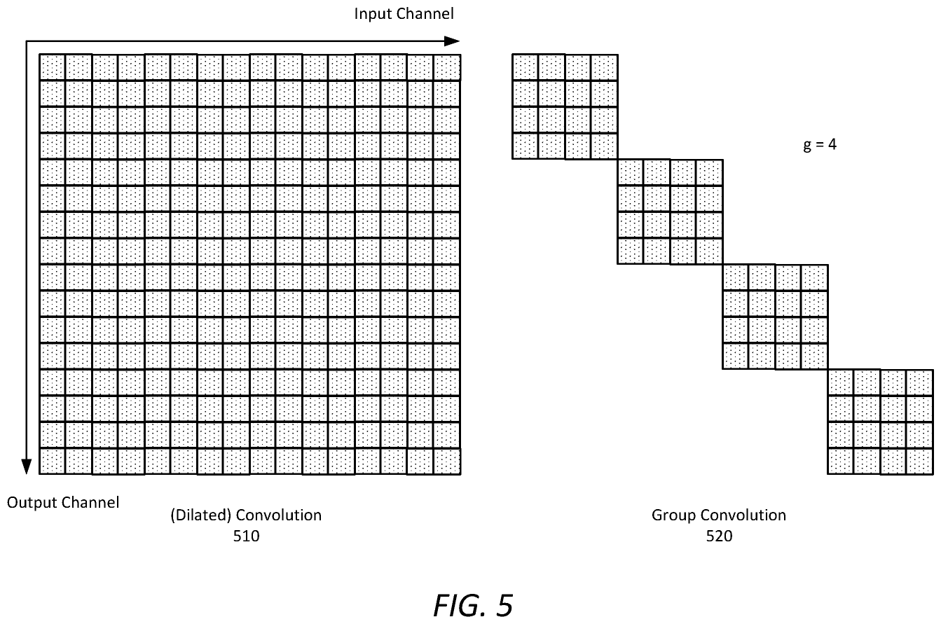

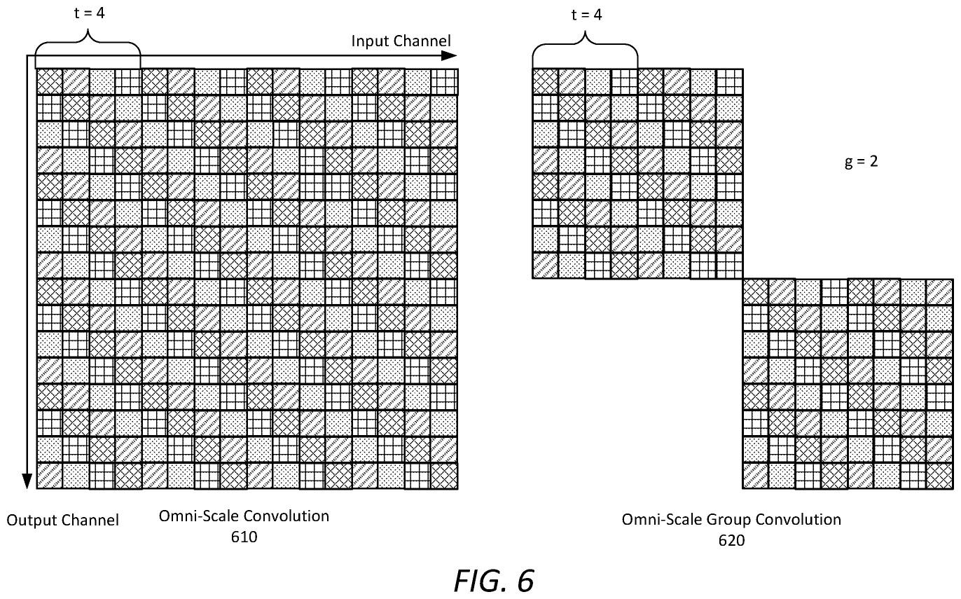

FIG. 5 is an illustration of dilation space of the kernel lattice in standard, dilated, or group convolution, according to some embodiments. For a convolutional layer, the kernel lattice refers to the two-dimensional flattened view of convolutional filters in which the kernel space is reduced while the channel space is retained, and thus each cell in the lattice represents an individual kernel. In FIG. 5, the kernels of the kernel lattice for standard or dilated convolution 510 are illustrated, with the input channel and the output channel being denoted. Also illustrated in FIG. 5 are the kernels of the kernel space for group convolution, with group number g=4. FIGS. 5 and 6 are illustrated from a vertical view of the kernel lattices in each such figure.

However, dilated convolution adds a fixed spatial sampling offset to standard convolution, enlarging the receptive field of convolution operations without introducing learnable parameters. In standard, dilated, or group convolution as illustrated in FIG. 5, all kernels have the same convolution rate (as illustrated by the uniform shading of the kernels in the kernel lattices for 510 and 520). In the standard convolution illustrated in FIG. 5, if a dilation rate is applied for dilated convolution, this dilation rate will add a spatial sampling offset to standard convolution. However, the dilation rate is fixed throughout the convolution. (The dilation rate of the standard or group convolution is always a value of 1.)

In some embodiments, omni-convolution is applied to allow for varying convolution rate for the kernels within the kernel lattice of a convolutional layer, thus enabling improvement in the performance of such layers in addressing varying scales of objects processed by a CNN.

FIG. 6 is an illustration of dilation space of the kernel lattice in omni-scale convolution, according to some embodiments. In FIG. 6, the kernels of the kernel lattice for omni-scale convolution 610 are illustrated. Also illustrated is omni-scale group convolution 620, with group number g=2. In contrast with standard convolution, the omni-scale convolution 610 and omni-scale group convolution 620 each have cyclic dilation rates, with the convolutions as illustrated having a cyclic interval of t=4. The cyclic pattern is shown with differing shading for each kernel having a particular dilation rate.

Thus, the omni-scale technology serves to reformulate the dilation rate patterns in the subspace of kernel lattice by utilizing both a cyclic strategy and a shift strategy. First, for an individual convolutional layer, in order to constrain the number of different dilation rates within a reasonable range, the dilation rates are heuristically arranged inside one filter with a cyclic strategy, i.e., dilation rates vary in a periodical manner along the axis of input channels. More specifically, a total of Cᵢₙ input

channels are divided into P partitions. For each partition,

$$t = ⌈ \frac{{C}_{in}}{p} ⌉$$

channels are accommodated and a fixed pattern of dilation rates {d₁, d₂, . . . , dₜ} is filled in to construct a row of the matrix D.

Second, the operation is expanded to all filters within a convolution layer. In order to endow different filters with capacities to gather different kinds of scale combinations of input features, the omni-scale convolution technology includes a shift strategy for dilation rates to flip the former filter to the latter one, i.e., the pattern of dilation rates regarding a convolutional filter is shifted by one channel to build its adjacent filter of an individual convolutional layer. In the illustrative example provided in FIG. 6, Cᵢₙ=Cₒᵤₜ=16 and the partition number P is set to 4, and hence this leaves a blank of 4 dilation rates to be determined in the pattern {d₁, d₂, . . . , dₜ}, where a specific shading distinguishes each type of dilation rate from others. It is noted that viewed from the axis of output channels, the dilation rates also present periodical variation. In other words, all types of dilation rates occur alternately along the vertical and horizontal axes in the trellis. The cyclic and shift operations for the dilation rates are also illustrated in FIG. 4 in which G 420 represents Cₒᵤₜ groups of convolutional filters along Cᵢₙ input channels.

Omni-scale convolution provides a novel technology that enables mixing of multi-scale information in two orthogonal dimensions, and leveraging the complementary multi-scale benefits such a fine granularity. In this manner, each individual convolutional layer in a convolutional neural network thus can resemble a feature pyramid and operate to overcome deficiencies in scaling of such convolutional layers.

FIG. 7 is a flowchart to illustrate a process for of omni-scale convolution in a convolutional neural network, according to some embodiments. The process 700 may be performed by processing logic that may include hardware (e.g., circuitry, dedicated logic, programmable logic, etc.), software (such as instructions run on a processing device), or a combination thereof. More particularly, the process 700 may be implemented in one or more modules as a set of logic instructions stored in a machine- or computer-readable storage medium such as RAM (Random Access Memory), ROM (Read Only Memory), PROM (Programmable Read Only Memory), firmware, flash memory, etc., in configurable logic such as, for example, PLAs, FPGAs (Field-Programmable Gate Arrays), CPLDs (Complex Programmable Logic Devices), in fixed-functionality logic hardware using circuit technology such as, for example, ASIC (Application-Specific Integrated Circuit), CMOS (Complementary Metal-Oxide-Semiconductor) or TTL (Transistor-Transistor Logic) technology, or any combination thereof

In some embodiments, the process 700 includes obtaining a CNN model for the processing of input data 705, wherein the CNN includes, but is not limited to, operation in computer vision functions. The CNN model may comprise a number of trained parameters hierarchically organized with a computational graph. The input data, such as images and videos, may in particular be used for image and video recognition, image classification, and medical image analysis. However, embodiments are not limited a particular type of data processing, and may include application in other fields.

However, the CNN may not be expected to have sufficient sensitivity to differences in scales of objects, thus potentially causing issues in efficient and effective processing of the input data, such as in computer vision operations. In some embodiments, to address such limitations, omni-scale processing technology is incorporated into the CNN backbone in order to provide improved processing at varying scales 710.

In some embodiments, the incorporation of omni-scale technology includes modifying one or more convolutional layers of the CNN 720, with the modification of a convolutional layer including adjustment of dilation rates for individual filters and for the full convolutional layer. In some embodiments, the modification includes establishing a group of dilation rates for filters within the kernel lattice for a convolutional layer 725, with the constituent kernels of the filter thus to use a group of dilation rates to extract features corresponding to different receptive fields; and establishing a cyclic pattern along input and output channels of the kernel lattice of the convolutional layer 730, thus allowing for extracting diverse scale information from the incoming features and mapping them into outgoing features in a wide range of scales. This may include, for example, the set of dilation rates (four dilation rates in this example) illustrated in FIG. 6, and the cyclic pattern of such dilation rates along the input and output channels for both the omni-scale convolution 610 and the omni-scale group convolution 620.

In some embodiments, the process then proceeds with processing the input data with the CNN utilizing the varying dilation rates in the cyclic pattern in the one or more convolutional layers 755, and ultimately producing an output from the CNN 760 based on the received input data.

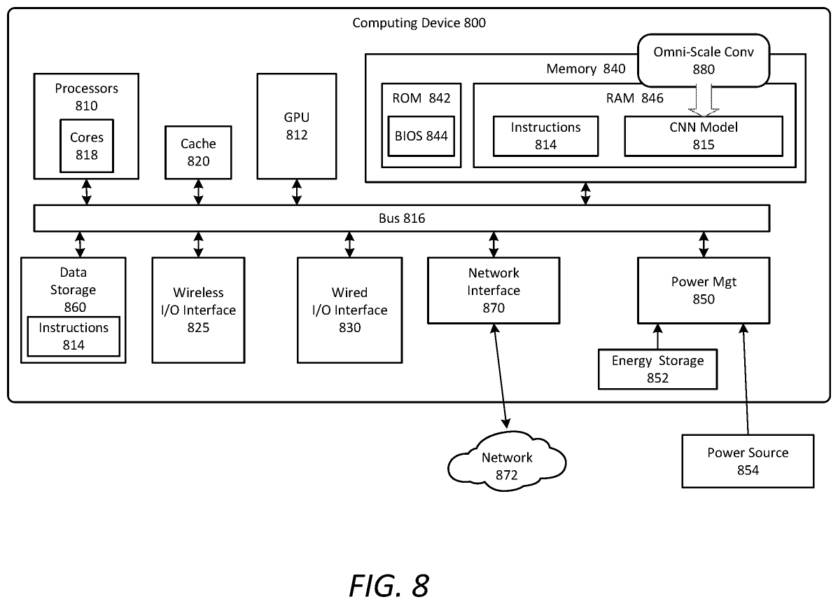

FIG. 8 is a schematic diagram of an illustrative electronic computing device to enable omni-scale convolution in a convolutional neural network, according to some embodiments. In some embodiments, an example computing device 800 includes one or more processors 810 including one or more processors cores 818. In some embodiments, the computing device is to provide omni-scale convolution in a CNN, as further illustrated in FIGS. 1-7. The CNN may include, but is not limited to, processing for computer vision operations.

In some embodiments, the computing device 800 is to, with regard to a single convolutional filter of a CNN, provide constituent kernels of a filter that use a group of dilation rates to extract features corresponding to different receptive fields; and, with regard to all convolutional filters in one single layer of the CNN, alternated the group of dilation rates corresponding to each convolutional filter along the axes of input and output channels in a cyclic fashion, extracting diverse scale information from the incoming features and mapping them into outgoing features in a wide range of scales.

The computing device 800 further includes memory 840, which may include read-only memory (ROM) 842 and random access memory (RAM) 846. A portion of the ROM 842 may be used to store or otherwise retain a basic input/output system (BIOS) 844. The BIOS 844 provides basic functionality to the computing device 800, for example by causing the processor cores 818 to load and/or execute one or more machine-readable instruction sets 814. In embodiments, at least some of the one or more machine-readable instruction sets 814 cause at least a portion of the processor cores 818 to process and to process data. The memory 840 may further include storage of a convolutional neural network (CNN) model 815 for processing of input data, such as images and video. In some embodiments, the CNN processing includes the application of an omni-scale convolution operation or tool 880, wherein the omni-scale convolution includes combination of a cyclic operation and a shift operation in a plurality of dilation rates for a plurality of kernels of one or more convolutional layers. In some embodiments, the one or more instruction sets 814 may be stored in one or more data storage devices 860, wherein the processor cores 818 are capable of reading data and/or instruction sets 814 from one or more non-transitory data storage devices 860 and writing data to the one or more data storage devices 860.

Computing device 800 is a particular example of a processor based device. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The example computing device 800 may be implemented as a component of another system such as, for example, a mobile device, a wearable device, a laptop computer, a tablet, a desktop computer, a server, etc. In one embodiment, computing device 800 includes or can be integrated within (without limitation): a server-based gaming platform; a game console, including a game and media console; a mobile gaming console, a handheld game console, or an online game console. In some embodiments the computing device 800 is part of a mobile phone, smart phone, tablet computing device or mobile Internet-connected device such as a laptop with low internal storage capacity. In some embodiments the computing device 800 is part of an Internet-of-Things (IoT) device, which are typically resource-constrained devices. IoT devices may include embedded systems, wireless sensor networks, control systems, automation (including home and building automation), and other devices and appliances (such as lighting fixtures, thermostats, home security systems and cameras, and other home appliances) that support one or more common ecosystems, and can be controlled via devices associated with that ecosystem, such as smartphones and smart speakers.

Computing device 800 can also include, couple with, or be integrated within: a wearable device, such as a smart watch wearable device; smart eyewear or clothing enhanced with augmented reality (AR) or virtual reality (VR) features to provide visual, audio or tactile outputs to supplement real world visual, audio or tactile experiences or otherwise provide text, audio, graphics, video, holographic images or video, or tactile feedback; other augmented reality (AR) device; or other virtual reality (VR) device. In some embodiments, the computing device 800 includes or is part of a television or set top box device. In one embodiment, computing device 800 can include, be coupled with, or be integrated within a self-driving vehicle such as a bus, tractor trailer, car, motor or electric power cycle, plane, or glider (or any combination thereof). The self-driving vehicle may use computing system 800 to process the environment sensed around the vehicle.

The computing device 800 may additionally include one or more of the following: a memory cache 820, a graphical processing unit (GPU) 812 (which may be utilized as a hardware accelerator in some implementations), a wireless input/output (I/O) interface 825, a wired I/O interface 830, power management circuitry 850, an energy storage device 852, a connection to external power source 854, and a network interface 870 for connection to a network 872. The following discussion provides a brief, general description of the components forming the illustrative computing device 800. Example, non-limiting computing devices 800 may include a desktop computing device, blade server device, workstation, or similar device or system.

The computing device 800 includes a bus or similar communications link 816 that communicably couples and facilitates the exchange of information and/or data between the various system components. The computing device 800 may be referred to in the singular herein, but this is not intended to limit the embodiments to a single computing device 800, since in certain embodiments, there may be more than one computing device 800 that incorporates, includes, or contains any number of communicably coupled, collocated, or remote networked circuits or devices.

The processor cores 818 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions. The processor cores 818 may include (or be coupled to) but are not limited to any current or future developed single- or multi-core processor or microprocessor, such as: one or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 8 are of conventional design. Consequently, such blocks need not be described in further detail herein, as they will be understood by those skilled in the relevant art. The bus 816 that interconnects at least some of the components of the computing device 800 may employ any currently available or future developed serial or parallel bus structures or architectures.

The at least one wireless I/O interface 825 and at least one wired I/O interface 830 may be communicably coupled to one or more physical output devices (tactile devices, video displays, audio output devices, hardcopy output devices, etc.). The interfaces may be communicably coupled to one or more physical input devices (pointing devices, touchscreens, keyboards, tactile devices, etc.). The at least one wireless I/O interface 825 may include any currently available or future developed wireless I/O interface. Examples of wireless I/O interfaces include, but are not limited to Bluetooth®, near field communication (NFC), and similar. The wired I/O interface 830 may include any currently available or future developed I/O interface. Example wired I/O interfaces include, but are not limited to universal serial bus (USB), IEEE 1394 (“FireWire”), and similar.

The data storage devices 860 may include one or more hard disk drives (HDDs) and/or one or more solid-state storage devices (SSDs). The one or more data storage devices 860 may include any current or future developed storage appliances, network storage devices, and/or systems. Non-limiting examples of such data storage devices 860 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 860 may include one or more removable storage devices, such as one or more flash drives, flash memories, flash storage units, or similar appliances or devices capable of communicable coupling to and decoupling from the computing device 800.

The one or more data storage devices 860 may include interfaces or controllers (not shown) communicatively coupling the respective storage device or system to the bus 816. The one or more data storage devices 860 may store, retain, or otherwise contain machine-readable instruction sets, data structures, program modules, data stores, databases, logical structures, and/or other data useful to the processor cores 818 and/or graphics processor circuitry 812 and/or one or more applications executed on or by the processor cores 818 and/or graphics processor circuitry 812. In some instances, one or more data storage devices 860 may be communicably coupled to the processor cores 818, for example via the bus 816 or via one or more wired communications interfaces 830 (e.g., Universal Serial Bus or USB); one or more wireless communications interfaces 825 (e.g., Bluetooth®, Near Field Communication or NFC); and/or one or more network interfaces 870 (IEEE 802.3 or Ethernet, IEEE 802.11, or Wi-Fi®, etc.).

Processor-readable instruction sets 814 and other programs, applications, logic sets, and/or modules may be stored in whole or in part in the system memory 840. Such instruction sets 814 may be transferred, in whole or in part, from the one or more data storage devices 860. The instruction sets 814 may be loaded, stored, or otherwise retained in system memory 840, in whole or in part, during execution by the processor cores 818 and/or graphics processor circuitry 812.

In embodiments, the energy storage device 852 may include one or more primary (i.e., non-rechargeable) or secondary (i.e., rechargeable) batteries or similar energy storage devices. In embodiments, the energy storage device 852 may include one or more supercapacitors or ultracapacitors. In embodiments, the power management circuitry 850 may alter, adjust, or control the flow of energy from an external power source 854 to the energy storage device 852 and/or to the computing device 800. The power source 854 may include, but is not limited to, a solar power system, a commercial electric grid, a portable generator, an external energy storage device, or any combination thereof.

For convenience, the processor cores 818, the graphics processor circuitry 812, the wireless I/O interface 825, the wired I/O interface 830, the data storage device 860, and the network interface 870 are illustrated as communicatively coupled to each other via the bus 816, thereby providing connectivity between the above-described components. In alternative embodiments, the above-described components may be communicatively coupled in a different manner than illustrated in FIG. 8. For example, one or more of the above-described components may be directly coupled to other components, or may be coupled to each other, via one or more intermediary components (not shown). In another example, one or more of the above-described components may be integrated into the processor cores 818 and/or the graphics processor circuitry 812. In some embodiments, all or a portion of the bus 816 may be omitted and the components are coupled directly to each other using suitable wired or wireless connections.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may utilize one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but utilize addition of a library (e.g., a dynamic link library (DLL)), a software development kit (SDK), an application programming interface (API), etc. in order to execute the instructions on a particular computing device or other device. In another example, the machine readable instructions may be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIG. 8 and other described processes may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order, or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments.

In Example 1, an apparatus includes one or more processors to process data, including processing for a convolutional neural network (CNN); and a memory to store data, including data for CNN processing, wherein processing of input data by the CNN includes the one or more processors implementing omni-scale convolution in one or more convolutional layers of the CNN, implementation of the omni-scale convolution into a convolutional layer of the one or more convolutional layers including at least: applying a plurality of dilation rates in a plurality of kernels of a kernel lattice of the convolutional layer, and applying a cyclic pattern for the plurality of dilation rates in the plurality of kernels of the convolutional layer.

In Example 2, the omni-scale convolution is to mix multi-scale information in two orthogonal dimensions of the kernel lattice for the convolutional layer.

In Example 3, mixing multi-scale information in two orthogonal dimensions includes the dilation rates of the plurality of kernels alternating along both an input channel and an output channel in the cyclic pattern.

In Example 4, the implementation of the omni-scale convolution provides a combination of a cyclic operation in which dilation rates for the plurality of kernels vary in a periodic manner along an axis of input channels; and a shift operation in which dilation rates for the plurality of kernels are shifted along an axis of output channels.

In Example 5, applying the plurality of dilation rates in the plurality of kernels includes implementing the dilation rates in group convolution.

In Example 6, the one or more processors are further to generate an output based at least in part on the omni-scale convolution in one or more convolutional layers of the CNN.

In Example 7, the omni-scale convolution is implemented in multiple convolutional layers of the CNN.

In Example 8, the omni-scale convolution is incorporated in an existing CNN structure.

In Example 9, at least one non-transitory machine readable storage medium comprises instructions that, when executed, cause at least one processor to perform operations including implementing a convolution operation in one or more convolutional layers of a convolutional neural network (CNN), including at least applying a plurality of dilation rates in a plurality of kernels of a kernel lattice of a convolutional layer of the one or more convolutional layers, and applying a cyclic pattern for the plurality of dilation rates in the plurality of kernels of the convolutional layer; receiving a set of input data for processing by the CNN; and utilizing the CNN to generate an output, including applying the plurality of dilation rates according to the cyclic pattern in the one or more convolutional layers.

In Example 10, the medium further includes instructions to perform operations including mixing multi-scale information in two orthogonal dimensions of the kernel lattice for the convolutional layer.

In Example 11, mixing multi-scale information in two orthogonal dimensions includes the dilation rates of the plurality of kernels alternating along both an input channel and an output channel in the cyclic pattern.

In Example 12, the implementation of the convolution operation includes a combination of: a cyclic operation in which dilation rates for the plurality of kernels vary in a periodic manner along an axis of input channels; and a shift operation in which dilation rates for the plurality of kernels are shifted along an axis of output channels.

In Example 13, applying the plurality of dilation rates in the plurality of kernels includes implementing the dilation rates in group convolution.

In Example 14, the implementation of convolution is provided in multiple convolutional layers of the CNN.

In Example 15, a system includes one or more processors to process data, including computer vision processing utilizing a convolutional neural network (CNN), the CNN including one or more convolutional layers; a memory to store data, including data for CNN processing; and an omni-convolution tool to provide support for objection recognition by the CNN in varying scales of object sizes, wherein application of the omni-convolution tool includes at least: applying a plurality of dilation rates in a plurality of kernels of a kernel lattice of a convolution layer of the one or more convolutional layers of the CNN, and applying a cyclic pattern for the plurality of dilation rates in the plurality of kernels of the convolutional layer.

In Example 16, application of the omni-scale convolution tool is to mix multi-scale information in two orthogonal dimensions of the kernel lattice for the convolutional layer.

In Example 17, mixing multi-scale information in two orthogonal dimensions includes the dilation rates of the plurality of kernels alternating along both an input channel and an output channel in the cyclic pattern.

In Example 18, application of the omni-scale convolution tool provides a combination of: a cyclic operation in which dilation rates for the plurality of kernels vary in a periodic manner along an axis of input channels; and a shift operation in which dilation rates for the plurality of kernels are shifted along an axis of output channels.

In Example 19, applying the plurality of dilation rates in the plurality of kernels includes applying the dilation rates in group convolution.

In Example 20, the system is further to generate an output based at least in part on the application of the omni-convolution tool in one or more convolutional layers of the CNN.

In Example 21, an apparatus includes means for implementing a convolution operation in one or more convolutional layers of a convolutional neural network (CNN), including at least applying a plurality of dilation rates in a plurality of kernels of a kernel lattice of a convolutional layer of the one or more convolutional layers, and applying a cyclic pattern for the plurality of dilation rates in the plurality of kernels of the convolutional layer; means for receiving a set of input data for processing by the CNN; and means for utilizing the CNN to generate an output, including applying the plurality of dilation rates according to the cyclic pattern in the one or more convolutional layers.

In Example 21, the apparatus further includes means for mixing multi-scale information in two orthogonal dimensions of the kernel lattice for the convolutional layer.

In Example 22, the means for mixing multi-scale information in two orthogonal dimensions includes the dilation rates of the plurality of kernels alternating along both an input channel and an output channel in the cyclic pattern.

In Example 23, the means for implementing the convolution operation includes a combination of: a cyclic operation in which dilation rates for the plurality of kernels vary in a periodic manner along an axis of input channels; and a shift operation in which dilation rates for the plurality of kernels are shifted along an axis of output channels.

In Example 24, applying the plurality of dilation rates in the plurality of kernels includes implementing the dilation rates in group convolution.

In Example 25, the implementation of convolution is provided in multiple convolutional layers of the CNN.

Specifics in the Examples may be used anywhere in one or more embodiments.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. An apparatus comprising:
one or more processors to process data, including processing for a convolutional neural network (CNN); and
a memory to store data, including data for CNN processing;
wherein processing of input data by the CNN includes the one or more processors implementing omni-scale convolution in one or more convolutional layers of the CNN, implementation of the omni-scale convolution into a convolutional layer of the one or more convolutional layers including at least:
applying a plurality of dilation rates in a plurality of kernels of a kernel lattice of the convolutional layer, and
applying a cyclic pattern for the plurality of dilation rates in the plurality of kernels of the convolutional layer.

2. The apparatus of claim 1, wherein the omni-scale convolution is to mix multi-scale information in two orthogonal dimensions of the kernel lattice for the convolutional layer.

3. The apparatus of claim 2, wherein mixing multi-scale information in two orthogonal dimensions includes the dilation rates of the plurality of kernels alternating along both an input channel and an output channel in the cyclic pattern.

4. The apparatus of claim 2, wherein the implementation of the omni-scale convolution provides a combination of:
a cyclic operation in which dilation rates for the plurality of kernels vary in a periodic manner along an axis of input channels; and
a shift operation in which dilation rates for the plurality of kernels are shifted along an axis of output channels.

5. The apparatus of claim 1, wherein applying the plurality of dilation rates in the plurality of kernels includes implementing the dilation rates in group convolution.

6. The apparatus of claim 1, wherein the one or more processors are further to generate an output based at least in part on the omni-scale convolution in one or more convolutional layers of the CNN.

7. The apparatus of claim 1, wherein the omni-scale convolution is implemented in multiple convolutional layers of the CNN.

8. The apparatus of claim 1, wherein the omni-scale convolution is incorporated in an existing CNN structure.

9. At least one non-transitory machine readable storage medium comprising instructions that, when executed, cause at least one processor to perform operations including:
implementing a convolution operation in one or more convolutional layers of a convolutional neural network (CNN), including at least:
applying a plurality of dilation rates in a plurality of kernels of a kernel lattice of a convolutional layer of the one or more convolutional layers, and
applying a cyclic pattern for the plurality of dilation rates in the plurality of kernels of the convolutional layer;
receiving a set of input data for processing by the CNN; and
utilizing the CNN to generate an output, including applying the plurality of dilation rates according to the cyclic pattern in the one or more convolutional layers.

10. The at least one non-transitory machine readable storage medium of claim 9, further comprising instructions to perform operations including:
mixing multi-scale information in two orthogonal dimensions of the kernel lattice for the convolutional layer.

11. The at least one non-transitory machine readable storage medium of claim 10, wherein mixing multi-scale information in two orthogonal dimensions includes the dilation rates of the plurality of kernels alternating along both an input channel and an output channel in the cyclic pattern.

12. The at least one non-transitory machine readable storage medium of claim 10, wherein the implementation of the convolution operation includes a combination of:
a cyclic operation in which dilation rates for the plurality of kernels vary in a periodic manner along an axis of input channels; and
a shift operation in which dilation rates for the plurality of kernels are shifted along an axis of output channels.

13. The at least one non-transitory machine readable storage medium of claim 9, wherein applying the plurality of dilation rates in the plurality of kernels includes implementing the dilation rates in group convolution.

14. The at least one non-transitory machine readable storage medium of claim 9, wherein the implementation of convolution is provided in multiple convolutional layers of the CNN.

15. A system comprising:
one or more processors to process data, including computer vision processing utilizing a convolutional neural network (CNN), the CNN including one or more convolutional layers;
a memory to store data, including data for CNN processing; and
an omni-convolution tool to provide support for objection recognition by the CNN in varying scales of object sizes;
wherein application of the omni-convolution tool includes at least:
applying a plurality of dilation rates in a plurality of kernels of a kernel lattice of a convolution layer of the one or more convolutional layers of the CNN, and
applying a cyclic pattern for the plurality of dilation rates in the plurality of kernels of the convolutional layer.

16. The system of claim 15, wherein application of the omni-scale convolution tool is to mix multi-scale information in two orthogonal dimensions of the kernel lattice for the convolutional layer.

17. The system of claim 16, wherein mixing multi-scale information in two orthogonal dimensions includes the dilation rates of the plurality of kernels alternating along both an input channel and an output channel in the cyclic pattern.

18. The system of claim 16, wherein application of the omni-scale convolution tool provides a combination of:
a cyclic operation in which dilation rates for the plurality of kernels vary in a periodic manner along an axis of input channels; and
a shift operation in which dilation rates for the plurality of kernels are shifted along an axis of output channels.

19. The system of claim 16, wherein applying the plurality of dilation rates in the plurality of kernels includes applying the dilation rates in group convolution.

20. The system of claim 16, wherein the system is further to generate an output based at least in part on the application of the omni-convolution tool in one or more convolutional layers of the CNN.
